(19) United States
(12) Patent Application Publication
(10) Pub. No.: US 2006/0059071 A1
(43) Pub. Date: Mar. 16, 2006

(54) Method and system for separating personal data accounts

(75) Inventors: Benedicte Maitret, Paris (FR); Manuel Gruson, Paris (FR); Jean-Yves Leonnec, Issy Les Moulineux (FR)

Correspondence Address: YOUNG & THOMPSON, 745 SOUTH 23RD STREET, 2ND FLOOR, ARLINGTON, VA, 22202, US

(73) Assignee: FRANCE TELECOM, PARIS (FR)

(21) Appl. No.: 11/224,041

(22) Filed: Sep. 13, 2005

(30) Foreign Application Priority Data
Sep. 15, 2004 (FR) 04 09787

(51) Int. Cl. G06Q 40/00

(52) U.S. Cl. 705/35

(57) ABSTRACT

Method and system for separating a unified personal data account which is associated with at least two personal data services includes:
a step (40) for accessing the unified personal data account (128);
a step (50) for requesting separation into at least two personal data accounts which are each associated with different personal data services; and
a step (60) for distributing the elements of the unified personal data account between the at least two personal data accounts.

### TECHNICAL FIELD

The present invention relates to a method for separating personal data accounts.

### BACKGROUND TO THE INVENTION

On current data transfer networks, there are a large number of personal data services, such as address book, diary and task services, which allow users to store personal information in the form of elements in personal data accounts.

Users access and/or use this personal data by connecting to a personal data service and identifying themselves, for example, by means of an identification code. The personal data are then used and/or created automatically when the service is used or directly by the user.

By way of example, personal data services exist on Internet access portals, messaging services, on-line shopping services, services for access to networks from mobile telephone equipment.

The personal data accounts of the various services are completely separate from each other, so that modifications to one personal data account are ineffective with respect to another personal data account of the same user. It is therefore necessary to keep the personal data accounts up to date manually in order to ensure that all the accessible information is up to date.

In order to overcome this problem, the use of a single identifier to access a plurality of services has been developed.

However, this solution presents a significant security and confidentiality problem, a single identification code allowing access to all the personal data accounts and all the information being accessible from all the services.

Another solution consists in controlling the identifiers in a distributed manner, allowing each service to access the personal data accounts of the other services.

However, this solution presents a problem in terms of user-friendliness since the user must control the various personal data accounts, and brings about a distribution of the identifiers, all being equivalent, which presents a security problem.

The object of the present invention is to overcome the problems of user-friendliness and security by defining a method for separating personal data accounts which combines user-friendliness, security and confidentiality.

### SUMMARY OF THE INVENTION

To this end, the subject-matter of the invention is a method for separating a unified personal data account which is associated with at least two personal data services, characterised in that it comprises:
a step for accessing the personal data account;
a step for requesting separation into at least two personal data accounts which are each associated with different personal data services; and
a step for distributing the elements of the unified personal data account between the at least two personal data accounts.

According to other features of the method of the invention:
the distribution step consists in copying the unified personal data account to the personal data accounts;
the distribution step consists in transferring the data from the unified personal data account to only one of the two personal data accounts and removing the content of the other of these two personal data accounts;
the method further comprises a step for removing the unified personal data account after the distribution step;
the unified personal data account is created based on a method for unifying at least two personal data accounts, each of which is associated with at least one personal data service, comprising:
a step for accessing a first personal data account;
a step for transmitting a request to unify the first personal data account with at least a second target personal data account; and
a step for unifying the first account with the target account(s) in order to form a unified personal data account which is associated with all the services which were initially associated with the first account and with each target account.

The invention also relates to a system for separating a unified personal data account into at least two personal data accounts, each of which is associated with at least one personal data service, characterised in that it comprises means for separating the unified personal data account, comprising means for transmitting a request to separate the unified personal data account and means for distributing the elements of the unified personal data account between the at least two personal data accounts.

### BRIEF DESCRIPTION OF DRAWINGS

The invention will be better understood from a reading of the following description, given purely by way of example and with reference to the appended drawings, in which:

FIG. 1A is a general flow chart of the unification method of the invention;

FIG. 1B is a general flow chart of the method of the invention for separating a single account; and

FIG. 2 is a block diagram of a system using the method of the invention.

### DESCRIPTION OF PREFERRED EMBODIMENTS

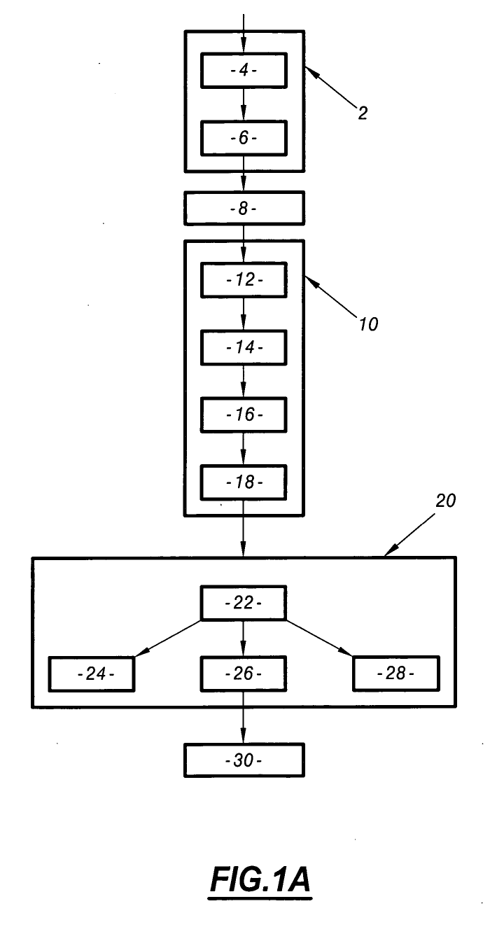

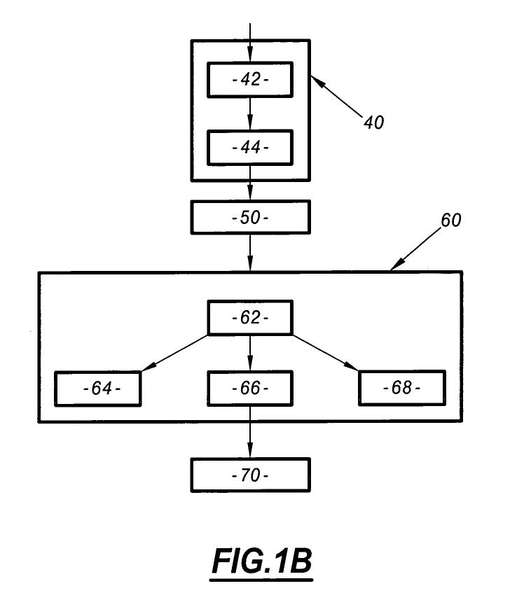

FIG. 1A is a flow chart of the method for unifying at least two personal data accounts according to the invention.

The example described of the method of the invention relates to two personal data accounts which are each associated with a personal data service which can be accessed, for example, via the Internet.

Of course, the method of the invention can be used with more than two personal data accounts and with types of network other than the Internet.

The unification method according to the invention begins with a step 2 for accessing a first personal data account. This step 2 first comprises a sub-step 4 for accessing a personal data service, such as, for example, an Internet messaging service. The sub-step 4 is followed by a sub-step 6 for identifying or authenticating the user of this service, for example, by acquiring a user name and an associated password in order to access the first personal data account.

The method then comprises a step 8 for transmitting a request to unify the first account with the second account, referred to as the “target account”. This step for transmitting a unification request is carried out, for example, by means of the presence, at the interface of the first personal data account, of a button which allows a unification request to be transmitted and which brings about the acquisition of information which allows the target personal data account to be determined for the unification request.

Advantageously, the step 8 for transmitting a request is followed by a step 10 for verifying the validity of this unification request.

In the embodiment described, this step 10 for verifying the validity of the request comprises a sub-step 12 for automatic transmission of a message intended for the target account, followed by a sub-step 14 for accessing a personal data service which allows access to the target account and a sub-step 16 for authenticating the user of this service. The sub-steps 14 and 16 therefore allow the collection of the information contained in the message which is transmitted automatically. After the target account has been accessed, the method comprises a sub-step 18 for replying to the message which is automatically sent during the sub-step 12, this sub-step 18 constituting validation of the unification request.

All of these sub-steps 12 to 18 thus ensure that the user of the target account authorises the use thereof, in order to prevent use or unification with a personal data account without the consent of the user thereof.

The step 10 for verifying the validity of the request is followed by a step 20 for merging the first personal data account and the target personal data account in order to form a new personal data account which is referred to as the “unified account” and which is associated with all the services associated with the first account and the target account.

This unified account can be accessed both using the identifier initially associated with the first personal data account and using the identifier associated with the target personal data account.

The unification step 20 begins with a sub-step 22 for the user to select a unification strategy. In the embodiment described, three strategies are proposed for controlling the identical elements: complete merging of the elements of the two personal data accounts corresponding to the sub-step 24, automatic duplicate detection implemented during a sub-step 26, and duplicate control which is carried out directly by the user of a sub-step 28 in order to select, each time a duplicate is detected, whether the two elements must be retained or whether one of them must be destroyed.

Advantageously, step 20 for unifying the personal data accounts in the unified account is followed by a step 30 for removing the first personal data account and the target account so as to retain only the unified personal data account.

In this manner, using the unification method of the invention, the user selects precisely the personal data accounts which are unified and then has a unified personal data account which can be accessed from a plurality of services.

By way of example, a user can unify personal address data accounts in order to create a unified account which can be accessed from an Internet access portal and a mobile access portal, any modification carried out to the address data from one of these services being visible from the other.

Of course, other embodiments of the method of the invention may be envisaged, in particular with regard to accessing the various personal data accounts and with regard to verifying the validity of the unification request. In particular, the verification can in particular make use of identification verification means or a distributed system.

Furthermore, the unification may be intended for personal data accounts of various users who wish to share some of their resources.

Two messaging users can thus unify their address books using the method of the invention whilst each retaining their identification protocol and limiting the unification only to this personal address book data, all the other pieces of data being protected in conventional manner.

This allows security and user-friendliness to be increased, the identifier of a specific user being recognised only on his own service but the unified personal data account being accessible from all the services.

Finally, other unification solutions may be envisaged. It is possible to create a new account which is intended to become the unified data account whilst retaining the original personal data accounts. In the same manner, it is possible to add the data of the other account(s) to one of the original accounts in order to produce the unified personal data account whilst retaining or destroying the original account(s).

In this manner, using this method of the invention, the user decides which are the personal data accounts which must be unified and, using the single account, he is able to access all the data from all the services for which the personal data accounts have been merged, without changing his use of the services.

This invention therefore allows various fields of use to be retained for the user, who accesses each service separately, whilst allowing him to control only a single personal data account.

In one variant, the step for verifying the validity of the request is carried out over an existing connection between the various accounts by means of direct dialogue.

FIG. 1B is a flow chart of the method for separating personal data accounts which corresponds to the unification method described with reference to FIG. 1A.

This method begins with a step 40 for accessing a unified data account, this step comprising, for example, a sub-step 42 for accessing a personal data service, followed by a sub-step 44 for identifying or authenticating the user using an identifier associated with the service.

This step 40 is followed by a step 50 for transmitting a request to separate the unified personal data account, which is followed by a step 60 for separation.

Various separation strategies may be envisaged and proposed to a user during a sub-step 62 for selecting the separation strategy.

These various strategies comprise, for example, complete duplication of the unified data account into two personal data accounts which are each associated with a different service during a sub-step 64, unilateral separation involving copying all the elements from the unified personal data account to a personal data account and creating another empty personal data account during a sub-step 66, and manual separation of the various elements of the unified personal data account and allocation thereof to one or other of the personal data accounts associated with the various services during a sub-step 68.

If the initial personal data accounts have been retained, the separation strategy used during step 60 may include a comparison of the elements included in the personal data accounts which already exist and the elements of the unified account.

Otherwise, if the personal data accounts which have been unified in order to form the unified data account have been destroyed, it is necessary to recreate them.

In one variant, during the unification, each element of the unified personal data account has been associated with an item of source information which allows the personal data account from which the element has been taken to be determined.

During the separation, this source information is used to distribute the various elements.

A similar solution is envisaged with the use of an item of information, for each element of the unified personal data account, which allows the user or the service which has created this element to be determined, this information being used during the separation step 60.

The step 60 is followed by a step 70 for removing the unified personal data account so that only the personal data accounts specific to each of the services exist at the end of the separation method of the invention.

For example, a user thus separates task data between two personal data accounts so that modifications to one account from one service will have no effect on the other account which can be accessed via another service.

Of course, other variants and embodiments of the separation method of the invention may be envisaged, and in particular other separation strategies and other methods for accessing the unified data account may be developed.

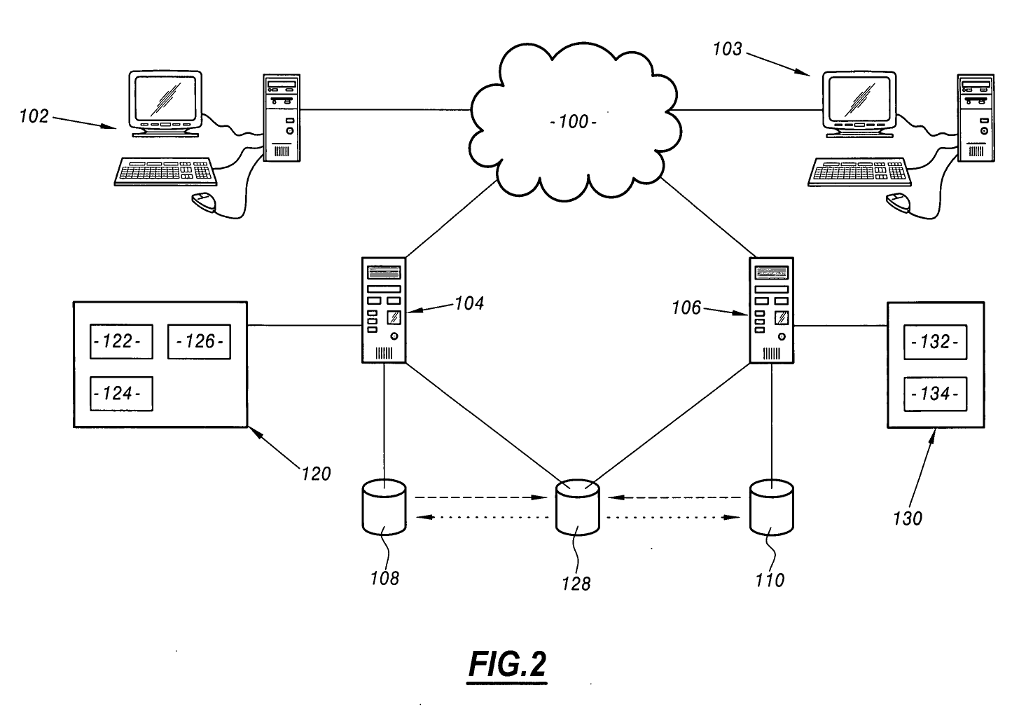

FIG. 2 is a schematic illustration of a personal data account unification and separation system which uses the unification and separation methods of the invention.

This system is organised around a data transfer network, such as the Internet 100, to which users have access from personal computers 102, 103 or any other type of suitable terminal, such as, for example, mobile telephones which are equipped with Internet access functions.

Various personal data services can be accessed via the network 100 by the users of the terminals 102 and 103 and in particular personal data services which are illustrated schematically by the servers 104 and 106, each of which is associated with a database which comprises a personal data account 108 and 110.

In conventional manner, the various elements of the system are suitable for communicating with each other using known electronic equipment and programs comprising the various elements which are required for their operation.

In particular, the servers 104 and 106 are suitable for verifying the identity of the users of the terminals 102 and 103, respectively, using conventional means for identifying a user, and for controlling the databases 108 and 110.

The system described further comprises, on at least one of the servers, such as the server 104, means 120 for unifying the personal data accounts, which means are suitable for implementing the unification method described with reference to FIG. 1A.

More particularly, the means 120 comprise a unit 122 for introducing a unification request which allows the identification of at least a second personal data account to be unified, referred to as the “target account”. This unit 122 is suitable for implementing step 8 for transmitting a unification request by a user.

The means 120 also comprise a unit 124 for verifying the validity of the request, which allows step 10 of the method described with reference to FIG. 1A to be implemented.

For example, the unit 124 is suitable for automatically transmitting a message intended for the server 106 which controls the target data account 110, this message having a short lifespan and being provided in order to automatically return an item of information as soon as it has been read, or this message comprising a confidential item of information to which it is necessary to have access in order then to be able to continue the unification procedure.

Finally, the means 120 comprise a unification unit 126 which is responsible for collecting the elements from the personal data accounts 108 and 110 in accordance with the strategy adopted in order to then form the unified data account 128.

Advantageously, at least one personal data service, such as the service illustrated by the server 106, comprises means 130 for separating a unified personal data account.

These means 130 comprise a unit 132 for acquiring a separation request and a separation unit 134.

During operation, the user of the terminal 102 connects to the personal data service illustrated by the server 104 via the network 100, thus implementing step 2 of the method illustrated in FIG. 1A.

The user then requests the unification of the personal data account 108 with the personal data account 110 using the unit 122.

The unit 124 for verifying the validity of the request then sends a message to the target account 110 from the personal data account 108. This message is collected by the user of the terminal 103 directly via the personal data service illustrated by the server 106, following satisfactory authentication. Once this message has been read, there follows a step for sending a message of consent in order to continue the unification operation.

Using the identification information contained in the message of consent, the user of the terminal 102 can continue the unification procedure.

The unit 124 thus implements step 10 of the method of FIG. 1A.

Once the validity of the request has been verified, the unit 126 carries out the unification of the personal data accounts 108 and 110 in order to form the personal data account 128 using the strategy adopted by the user or a strategy defined by default.

The unified personal data account 128 is created using conventional means for controlling databases, which means are included in the various personal data services.

This creation operation allows all the information from personal data accounts 108 and 110 to be included in the unified personal data account 128, as illustrated with dashed lines.

The unified data account which has been created in this manner can be accessed directly from each of the personal data services illustrated by the servers 104 and 106.

Furthermore, the user of the terminal 103 can use the means 130 for separating the unified data account by connecting to a personal data service which has access to the unified data account 128, such as the service illustrated by the server 106, using step 40 of the method illustrated in FIG. 1B.

The user then transmits a request to separate the unified data account 128 via the unit 132, thus implementing step 50 of the method of FIG. 1B.

The unit 134 then separates the unified personal data account 128 by implementing step 60 of the method of FIG. 1B.

If the personal data accounts 108 and 110 have not been destroyed during the creation of the unified data account 128, the unit 134 distributes the elements of the unified data account 128 between the data accounts 108 and 110 in accordance with the adopted strategy, for example, by copying the unified data account 128 to the data accounts 108 and 110 or by transferring all the data unilaterally to only one of the accounts and removing the entire contents of the other.

Otherwise, if the data accounts 108 and 110 have been destroyed during the creation of the unified data account 128, these accounts must be recreated in order to be able to transfer the data.

This transfer of data is illustrated with dotted lines in FIG. 2.

Of course, other embodiments of the system of the invention may be envisaged.

In particular, the unification means 120 and/or separation means 130 can be integrated in another server which can be accessed from the personal data services.

The various means and units of this system are generally formed by specific programs and software packages or program elements and software elements which comprise specific instructions which are intended to implement the various steps of the methods of the invention.

1. Method for separating a unified personal data account which is associated with at least two personal data services, the method comprising:
a step for accessing the unified personal data account;
a step for requesting separation into at least two personal data accounts which are each associated with different personal data services; and
a step for distributing the elements of the unified personal data account between the at least two personal data accounts.

2. Method according to claim 1, wherein the distribution step consists in copying the unified personal data account to the personal data accounts.

3. Method according to claim 1, wherein the distribution step consists in transferring the data from the unified personal data account to only one of the two personal data accounts and removing the content of the other of these two personal data accounts.

4. Method according to claim 1 and further comprising a step for removing the unified personal data account after the distribution step.

5. Method according to claim 2 and further comprising a step for removing the unified personal data account after the distribution step.

6. Method according to claim 3 and further comprising a step for removing the unified personal data account after the distribution step.

7. Method according to claim 1, wherein the unified personal data account is created based on a method for unifying at least two personal data accounts, each of which is associated with at least one personal data service, the unification method comprising:
a step for accessing a first personal data account;
a step for transmitting a request to unify the first personal data account with at least a second target personal data account; and
a step for unifying the first account with the target account(s) in order to form a unified personal data account which is associated with all the services which were initially associated with the first account and with each target account.

8. Method according to claim 2, wherein the unified personal data account is created based on a method for unifying at least two personal data accounts, each of which is associated with at least one personal data service, the unification method comprising:
a step for accessing a first personal data account;
a step for transmitting a request to unify the first personal data account with at least a second target personal data account; and
a step for unifying the first account with the target account(s) in order to form a unified personal data account which is associated with all the services which were initially associated with the first account and with each target account.

9. Method according to claim 3, wherein the unified personal data account is created based on a method for unifying at least two personal data accounts, each of which is associated with at least one personal data service, the unification method comprising:
a step for accessing a first personal data account;
a step for transmitting a request to unify the first personal data account with at least a second target personal data account; and
a step for unifying the first account with the target account(s) in order to form a unified personal data account which is associated with all the services which were initially associated with the first account and with each target account.

10. Method according to claim 4, wherein the unified personal data account is created based on a method for unifying at least two personal data accounts, each of which is associated with at least one personal data service, the unification method comprising:
a step for accessing a first personal data account;
a step for transmitting a request to unify the first personal data account with at least a second target personal data account; and
a step for unifying the first account with the target account(s) in order to form a unified personal data account which is associated with all the services which were initially associated with the first account and with each target account.

11. Method according to claim 5, wherein the unified personal data account is created based on a method for unifying at least two personal data accounts, each of which is associated with at least one personal data service, the unification method comprising:
a step for accessing a first personal data account;
a step for transmitting a request to unify the first personal data account with at least a second target personal data account; and
a step for unifying the first account with the target account(s) in order to form a unified personal data account which is associated with all the services which were initially associated with the first account and with each target account.

12. Method according to claim 6, wherein the unified personal data account is created based on a method for unifying at least two personal data accounts, each of which is associated with at least one personal data service, the unification method comprising:
a step for accessing a first personal data account;
a step for transmitting a request to unify the first personal data account with at least a second target personal data account; and
a step for unifying the first account with the target account(s) in order to form a unified personal data account which is associated with all the services which were initially associated with the first account and with each target account.

13. System for separating a unified personal data account into at least two personal data accounts, each of which is associated with at least one personal data service, wherein it comprises means for separating the unified personal data account, comprising means for transmitting a request to separate the unified personal data account and means for distributing the elements of the unified personal data account between the at least two personal data accounts.
